(19) United States
(12) Patent Application Publication
(10) Pub. No.: US 2005/0036470 A1
(43) Pub. Date: Feb. 17, 2005

(54) Multi-hop peer-to-peer wireless local loop phone system and method

(76) Inventor: Nathan Hunter Calvert, Austin, TX (US)

Correspondence Address: Nathan H. Calvert, 5808 N. Hampton Dr., Austin, TX, 78723, US

(21) Appl. No.: 10/884,535

(22) Filed: Jul. 2, 2004

Related U.S. Application Data
(60) Provisional application No. 60/492,454, filed on Aug. 4, 2003.
(60) Provisional application No. 60/553,691, filed on Mar. 16, 2004.

(51) Int. Cl. H04L 12/56; H04Q 7/24

(52) U.S. Cl. 370/338; 370/401

(57) ABSTRACT

A peer-to-peer wireless phone system with peer-to-peer units and network configuration algorithms by which a virtual circuit data path is established by minimizing the latency added at each hop starting with the external network gateway or the most loaded hop and choosing closest time slots for each next hop until a the virtual circuit is completed. Also, certain embodiments of the present invention include network configuration algorithms by which traffic around any external network gateway(s) is optimized to maximize throughput around the gateway by allocating certain of many available channels to a group of P2P units around the gateway, these units acting as an “infrastructure” through which other units route virtual circuits through the gateway. The network topology is also configured to let these units transmit at higher power levels and ranges than other P2P units in the network, and thereby help minimize the number of hops needed to reach the external network gateway. Further, other sets of units can be configured with similar larger transmit ranges (around 4 of the standard P2P hop ranges), positioned at such a range on the opposite side of from the gateway to also act as “infrastructure units”, both to pass calls forward to the group of units in the gateway's Point Coordinator group, and to also route circuits that are internal to the network around the Point Coordinator group on the gateway, thereby maximizing efficient use of the gateway capacity. Such rings or layers of infrastructure can be repeated as necessary to minimize hops as the network grows larger, making the tradeoff between minimizing hops (which maximizes transmit power and increases co-channel interference) and minimizing power (which maximizes the number of hops and produces poor latency).

### CROSS REFERENCE TO RELATED APPLICATIONS

This application claims the benefit of provisional application No. 60/492,454, filed Aug. 4, 2003, pending and provisional application No. 60/553,691, filed Mar. 16, 2004, pending.

### BACKGROUND OF THE INVENTION

1. Field of the Invention

The present invention relates to a peer-to-peer wireless local loop phone system for use in connection with providing low cost basic telecommunications service to customers. The peer-to-peer wireless local loop phone system has particular utility in connection with providing local phone service without the use phone lines or central base stations with a peer-to-peer multi-hop wireless phone terminal.

2. Description of the Prior Art

Wireless local loop phone systems are desirable connecting local phone subscribers to the PSTN and other data networks without the use of copper wires for the “last mile” connection. However, using centralized “cellular” wireless local loop has the drawback that expensive towers must be installed to provide coverage for the geographic area to which local loop phone service is provided. Another disadvantage of the cellular approach is that the towers must provide enough connections for all local phone calls as well as calls leaving the network. In many areas, the local phone service is a large majority of the phone traffic available, so the necessity for centrally switching local phone calls in either a wired or wireless system adds enormous costs to the network. Peer-to-Peer wireless systems are also known in the prior art. Such prior art systems have, however, been designed for broadband data traffic and battlefield multicast command and control applications, and have not been optimized for the strict latency requirements of telephone voice traffic. Further, the media access control portions of these interfaces have not been optimized to minimize latency or maximize the scalability of the network to accommodate a system that provides the cheapest possible coverage by minimizing the number of external network gateways needed to provide coverage to a large population.

A further disadvantage of the prior art peer-to-peer wireless systems is that their multiple access (wireless terminology) or media access control (networking terminology) is not optimized to provide access to the available wireless channel(s) to minimize latency while at the same time minimizing co-channel interference from other simultaneously transmitting peers in the network. Finally, the prior art systems also are not designed to optimize the above described performance parameters while at the same time maximizing throughput to the critically loaded external network gateway to maximize the efficiency of the external network gateway and thereby help minimize total connectivity cost of the system.

Therefore, a need exists for a new and improved peer-to-peer wireless local loop phone system that can be used for providing local phone service without the use phone lines or central base stations with a peer-to-peer multi-hop wireless phone terminal while providing low latency, low cost, and optimized spectrum-sharing attributes. In this respect, the peer-to-peer wireless local loop phone system according to the present invention substantially departs from the conventional concepts and designs of the prior art, and in doing so provides an apparatus and methods devised to provide local phone service without phone lines or central base stations with a peer-to-peer multi-hop wireless phone terminal.

### SUMMARY OF THE INVENTION

A present invention P2P unit (Peer-to-Peer transceiver and phone unit) is placed inside each subscribers home by a service provide such as, for example, the national or other telecom provider in the host community. When a user places a call, the base station plugged into a power outlet relays the call to other units nearby, passing the call between base stations until the call either reaches its destination within the local network area or is tied into the Public Switched Telephone Network (PSTN) (which is typically owned or controlled by the national telecommunication company) to create a peer-to-peer network.

The system of relaying calls through a combination of hops between the units creates a powerful network with low latency (voice delay/quality) levels. The local network requires no wire lines or central switching centers (although their existence by no means precludes the present invention's technology) to cover the geographical area or to make local calls. The need for only a single interconnection point to link the local peer network to the PSTN provides significant infrastructure installation savings over traditional wireline telephone services. The leveraging of local peer networks onto PSTN's via single interconnection points substantially reduces capital costs and allows Telcos the ability to affordably extend service to previously unreachable markets

In view of the foregoing disadvantages inherent in the known types of wireless local loop now present in the prior art, the present invention provides an improved peer-to-peer wireless local loop phone system, and overcomes the above-mentioned disadvantages and drawbacks of the prior art. As such, the general purpose of the present invention, which will be described subsequently in greater detail, is to provide a new and improved peer-to-peer wireless local loop phone system and method which has all the advantages of the prior art mentioned heretofore and many novel features that result in a peer-to-peer wireless local loop phone system which is not anticipated, rendered obvious, suggested, or even implied by the prior art, either alone or in any combination thereof.

To attain this, the present invention essentially comprises a P2P wireless communications system comprised of a plurality of wireless terminal units, wherein each wireless terminal unit functions both as a Point Coordinator for a selected group of other wireless terminal units, and as a client in another group of wireless terminal units with a different Point Coordinator.

The present invention also comprises network configuration algorithms by which a virtual circuit data path is established by minimizing the latency added at each hop starting with the external network gateway or the most loaded hop and choosing closest time slots for each next hop until a the virtual circuit is completed.

Also, certain embodiments of the present invention include network configuration algorithms by which traffic around any external network gateway(s) is optimized to maximize throughput around the gateway by allocating certain of many available channels to a group of P2P units around the gateway, these units acting as an “infrastructure” through which other units route virtual circuits through the gateway. The network topology is also configured to let these units transmit at higher power levels and ranges than other P2P units in the network, and thereby help minimize the number of hops needed to reach the external network gateway. Further, other sets of units can be configured with similar larger transmit ranges (around 4 of the standard P2P hop ranges), positioned at such a range on the opposite side of from the gateway to also act as “infrastructure units”, both to pass calls forward to the group of units in the gateway's Point Coordinator group, and to also route circuits that are internal to the network around the Point Coordinator group on the gateway, thereby maximizing efficient use of the gateway capacity. Such rings or layers of infrastructure can be repeated as necessary to minimize hops as the network grows larger, making the tradeoff between minimizing hops (which maximizes transmit power and increases co-channel interference) and minimizing power (which maximizes the number of hops and produces poor latency).

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a logical/topological diagram view of the preferred embodiment of the peer-to-peer wireless local loop phone system constructed in accordance one embodiment of the present invention.

FIG. 2 is a logical/topological diagram according to a preferred embodiment of the present invention.

FIG. 3 is a flow chart for initializing and configuring a new P2P unit in a network of certain embodiments of the present invention.

FIG. 4 is a flow chart of a process for establishing virtual circuit connections according to another embodiment of the present invention.

FIG. 5 is an architectural diagram of another embodiment of the present invention.

FIG. 6 is an architectural diagram of yet another embodiment of the present invention.

FIG. 7 is an architectural diagram of yet another embodiment of the present invention.

The same reference numerals refer to the same parts throughout the various figures. Different embodiments of the invention may have, however, different embodiments of particular parts.

### DESCRIPTION OF THE PREFERRED EMBODIMENT

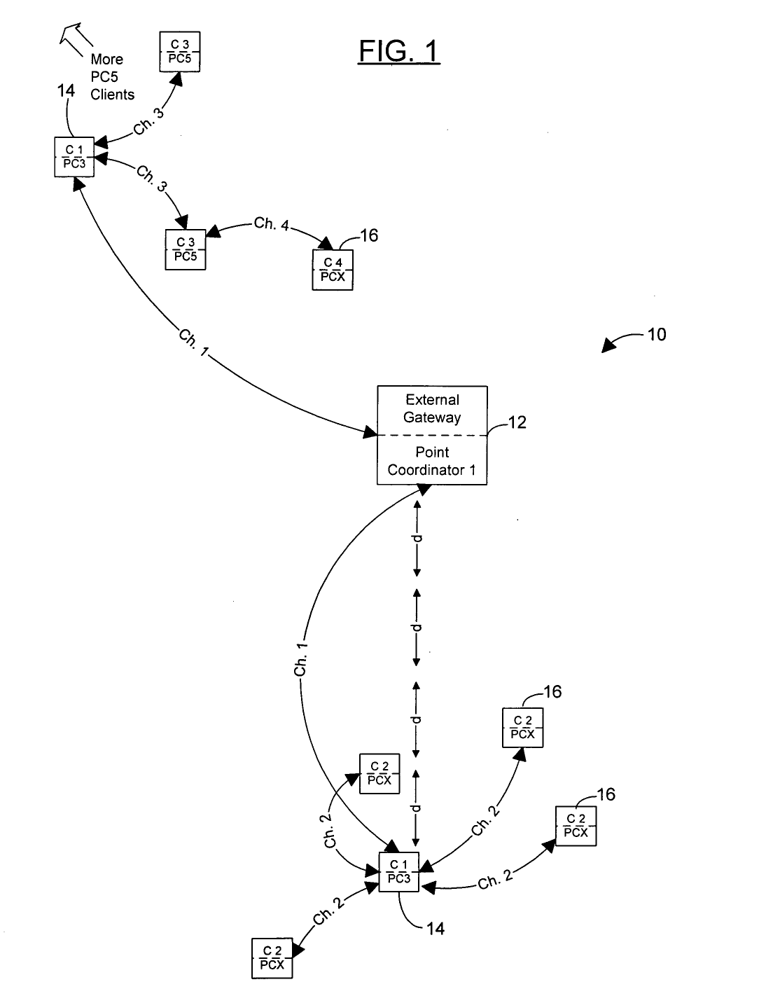

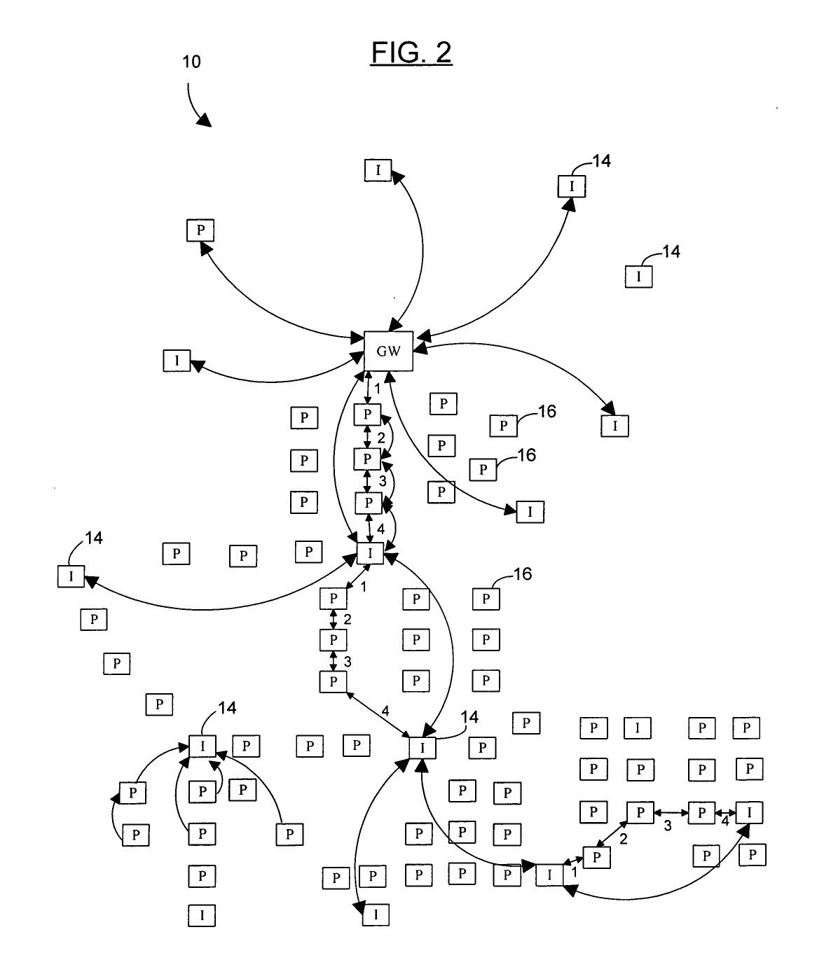

Referring now to the drawings, and particularly to FIGS. 1-2, a preferred embodiment of the peer-to-peer wireless local loop phone system of the present invention is shown and generally designated by the reference numeral 10.

In FIG. 1, a new and improved peer-to-peer wireless local loop phone system 10 of the present invention for providing local phone service without the use phone lines or central base stations with a peer-to-peer multi-hop wireless phone terminal is illustrated and will be described, with only the central portion of the network shown. More particularly, the peer-to-peer wireless local loop phone system 10 has a unit 12 external gateway connected to the PSTN or to the internet or other backbone gateway of some kind. Next the system 10 is comprised of peer-to-peer (P2P) units, which are not homogenous in their function, but take on different roles. The Gateway 12 connects to the infrastructure units 14 by radio transceivers, and the infrastructure units 14 share a multiple access channel by which they communicate to the gateway. This channel can be a TDMA type of system, a Wi-fi channel using the 802.11 point coordinator mode or some other similar time-divided scheme, or a CDMA scheme or some other hybrid scheme such as time division duplexing/CDMA. Further, the channel links designated by the curved lines to the gateway are on separate channels from the smaller links coming from the P2P units 16 to the infrastructure units 14. These channels may be selected from multiple available channels which are reused according to a geographic distribution channel-reuse schemes very similar to cellular mobile phone channel-reuse schemes, to minimize the co-channel interference given a certain number of available channels. Such schemes may involve a channel re-use constant K, which may be adjusted by the system 10 in a manner devised to increase the density of “cells” in a locally crowded area. The external gateway 12 acts as a point coordinator scheduling and handling the multiple access to channel 1 for the two nodes in its group (the nodes that are infrastructure units 14 with C1 for client 1 in the top of their box). Only two nodes are shown in this group, but there can be substantially more as described in FIG. 2. Also note that the external gateway will be the most congested portion of the network, so it is advantageous to provide it with more than one multiple access channel. For example, if the network were using Wi-fi hardware with modified MAC layer, the external gateway might be assigned channels 1 and 9. Each of the other units in the network can also function as a Point Coordinator for another multiple access channel, while they also act as a client on another multiple access channel. For instance, the uppermost infrastructure unit 14 in the figure is labeled C1 for client on channel 1 and PC3 for Point Coordinator on channel 3, and the nearby P2P units 16 are participating as clients on channel 3 for which that unit is a point coordinator. This network topology is discovered and fixed as the network is being formed, and evolves slowly as the network evolves. The route for a phone call virtual circuit is not determined as the call is made, but goes through the predetermined topology and routing. This enables “channel planning” and “network planning” in a function similar to that on cellular networks, and thereby achieves the scaling, throughput, load balancing, and latency goals that are not possible with current ad-hoc network configuration algorithms.

Note that the P2P units 16 do not access the gateway directly (unless the network is small enough not to need any infrastructure units 14). Rather, they hop through other P2P units until their circuit reaches an infrastructure unit 14 which can transmit to the gateway, these hops are designated by the shorter curved lines labeled Ch2 and Ch3. This scheme is for the purpose of providing a fixed framework through which the traffic load on the gateway can be distributed to optimize throughput at the gateway. Since the network topology does not change quickly, and the infrastructure units 14 and P2P units 16 are plugged into power outlets and fixed in customer's homes like other wireless local loop systems, the routing information can be stored in a fixed routing table scheme and updated as the network grows. Routes are discovered proactively rather than reactively.

For multi-hop connections, a virtual circuit connection is established from a P2P unit 16 either into the external gateway 10 or into another P2P unit 16. (For calls originating outside of the network, this process starts at the external gateway 10 and terminates into one of the P2P units.). A virtual circuit is established by minimizing the time delta between the receipt and transmit of data at each node along the path, optimized around the most-loaded node or around the external gateway. Note that each node in the network will store shortest-path virtual circuit routing data to the external gateway and to every other node in the network. This is manageable because an individual system 10 can scale to something on the order of 10,000 units, so the routing tables will be a manageable size. Also, each unit can store more than one next-hop route data for every route, making it possible to switch the virtual circuit over to another route at any point along the circuit should a connection in the route fail or the network congestion requires movement of connections for load balancing purposes. Finally, since the network evolves slowly as new units are turned on (and should be left plugged in and powered up), there is not a need for reactive route discovery techniques unless there are drastic external interference problems or multiple units are removed from the network simultaneously.

Referring now to FIG. 2, an expanded view of the network is shown where more units and multiple layers of the infrastructure units 14 are shown according to one embodiment of the present invention. A functional difference between infrastructure units 14 (all labeled as ‘I’) and P2P units 16 (all labeled as ‘P’)—the difference is that infrastructure units 14 transmit with more power because they have longer transmit hops to reach other infrastructure units 14 or external gateway 12. Further, infrastructure units 14 may act as Point Coordinators and assign multiple access channel slots or codes to other infrastructure units 14 as well as P2P units 16. The number of P2P hops that may be made before reaching an infrastructure unit determines the how far apart the infrastructure units can be. The normal transmit range of a P2P unit 16 is on the order of the distance indicated by the straight lines labeled ‘d’. Current theory and practice say that if the number of hops is substantially greater than 10, the latency of the system will be too great for voice. This number can of course be increased for calls that do not leave the network, since they will not include latency added by the external network. In this example, no P2P unit is more than 3 hops from an infrastructure node, this number can vary with as technology improves and the latency at each hop is lowered. One infrastructure unit 14 can serve a large number of P2P units 16 (and also handles its own originated calls). In this embodiment, on the order of magnitude of 20 units participate in the group for any unit acting as a point coordinator. This arrangement may be devised because the traffic model for voice calls which indicates a large percentage of the units will be not be placing calls at any given time. Such participation is consistent with current theory that at least each unit should be able to view around 8 units to achieve a totally connected network. Further, such participation means that many units may need only to function as clients, since the units around them may share the same point coordinator.

In FIG. 2, infrastructure unit 14 hops are designated with long curved lines, while P2P unit 16 hops are designated with shorter curved lines. Note that the current system described has units 14 and 16 that can function in a 2-level hierarchy, however more levels of hierarchy are consistent with the present invention. Such hierarchy may be employed if, for example, it is needed to help the networks scale to larger sizes and thereby decrease the costs of geographical coverage and increase efficiency of backbone connection (external gateway connections). Note that the units are separated by the distances designated by the straight lines, which is an expected distance between households in any given area. This distance will change depending on population density, but the average is expected to be on the order of 50 yards. In this embodiment, the individual hop distances designated by straight lines are not minimized even within a group of peers. As is shown by the hops designated in the lower left corner, P2P units 16 may transmit “over” other units to reach an infrastructure unit. Minimizing hop distance (as is well known in the art) typically maximizes hops and therefore maximizes latency. On the other hand, minimizing hops typically will maximize power and therefore maximize co-channel interference. The current invention trades off these two dimensions of variability and optimizes the problem for a fixed, wireless, peer-to-peer phone network to achieve maximum scalability within latency limits.

The system may also be devised to achieve efficient use of backbone/backhaul connections (lines going to the PSTN). Because peer-to-peer calls within the network (a large portion of the traffic for voice calls) do not go through the external gateway, the gateway may not need to provide capacity for handling these calls, and therefore backhaul circuits may be used in their most efficient way by providing only enough lines for the peak off-network (long distance) calling load. In an alternative embodiment, lower quality of service options might provide less than enough lines for expected peak off-network calls, and charge premium prices for guaranteed access to long distance or off-network service.

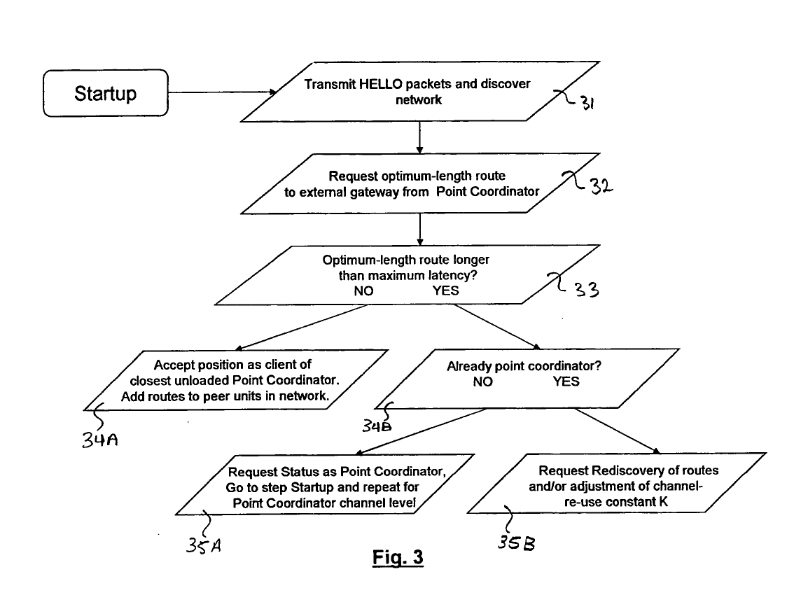

FIG. 3 is a flow chart for initializing and configuring a new P2P unit in a network of certain embodiments of the present invention. After startup of a unit for the first time in a new network or after a reset/reconfigure command is entered, step 32 transmits network discovery packets. Network and route discovery may proceed according to a number of procedures known in the art for discovering ad-hoc or peer-to-peer networks, such as, for example, CEDAR, CBRP, ZRP, OLSR, GSR, DSDV, WRP, DSR, and AODV. These protocols are typically, however, used with single-channel peer-to-peer networks and are, therefore, modified to recognize links on additional channels to implement a channel re-use pattern similar to cellular channel-reuse patterns known in the art. Preferably, step 31 uses proactive-type discovery and routing algorithm(s). Reactive algorithms may be used, however, where a system is configured to allow specified units to roam through the network 20 as mobile units, or when changing circumstances in the operating environment or network produce a more dynamic, rather than static, network status. If a new unit is being added to an established network, Step 31 may be limited to adding the unit to the network architecture and routing tables. Step 31 may request status as a Point Coordinator (to act as an infrastructure unit 14) in the second (or higher) infrastructure layer of the network if topology conditions, such as, for example, loading of the available point coordinators, warrant such a status. In alternative embodiments, step 31 may report to a centralized or partially centralized control server with data the transmitting unit's topological and/or geological location and receive status and topology instructions/assignments back from such a centralized control server. Such topology instructions may designate status as a point coordinator or member of a client group for a designated point coordinator as well as designated channels for a desired channel-reuse pattern. Step 32 requests an optimum length route to the external gateway from the designated point coordinator, or peer point-coordinator if the requesting unit has point coordinator status. Steps 33-35 determine the status of the activated or reconfigured unit in order to establish call-latency characteristics in accordance with pre-determined requirements.

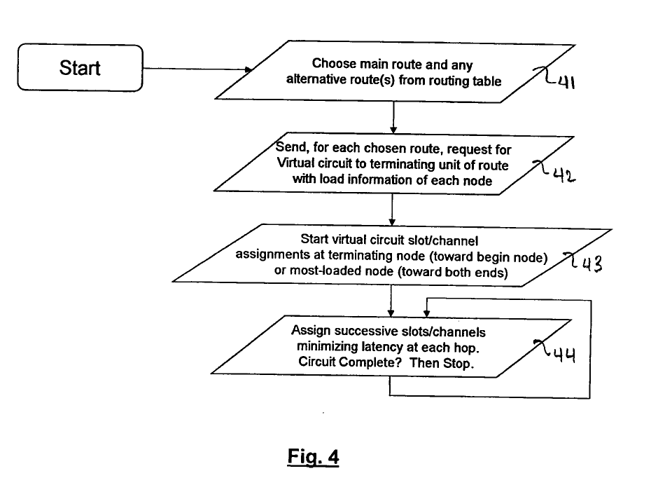

FIG. 4 is a flow chart of a process for establishing virtual circuit connections according to another embodiment of the present invention. In the start step, user data determines a destination for a particular virtual circuit connection (call) which may be in-network or out-of-network (through the external gateway). Step 41 chooses route(s) to implement to reach a desired call. Multiple routes may be chosen to implement backup/alternative routes in networks with a tendency toward low-reliability operating conditions, such as, for example, bad RF propagation characteristics or highly dynamic conditions. Steps 42-44 determine a virtual circuit connection arrangement devised to minimize latency and optimize resource used in the most-loaded node in the circuit. Such a most-loaded node will often be the external gateway when a call is outside the peer-to-peer network, or may alternatively be another node in the gateway. Step 44 minimizes latency at the current node by finding the next available time-slot or channel-slot for transmission after reception of a packet or frame of data from the previous node in the virtual circuit.

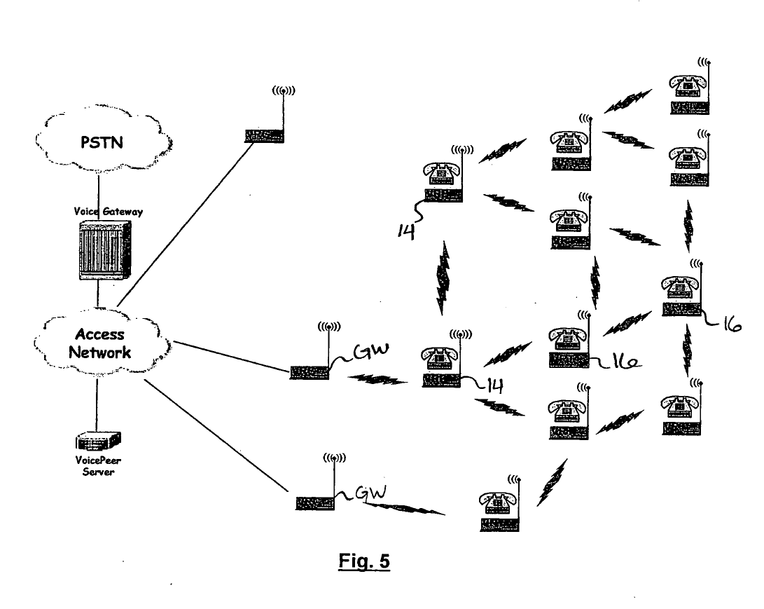

FIG. 5 is an architectural diagram of another embodiment of the present invention.

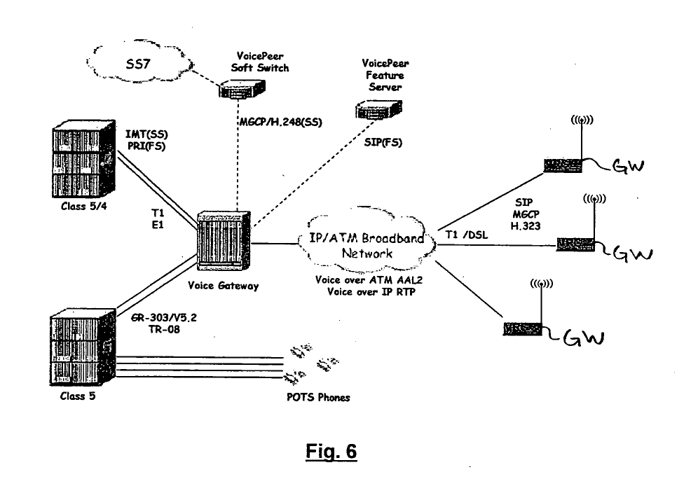

FIG. 6 is an architectural diagram of yet another embodiment of the present invention.

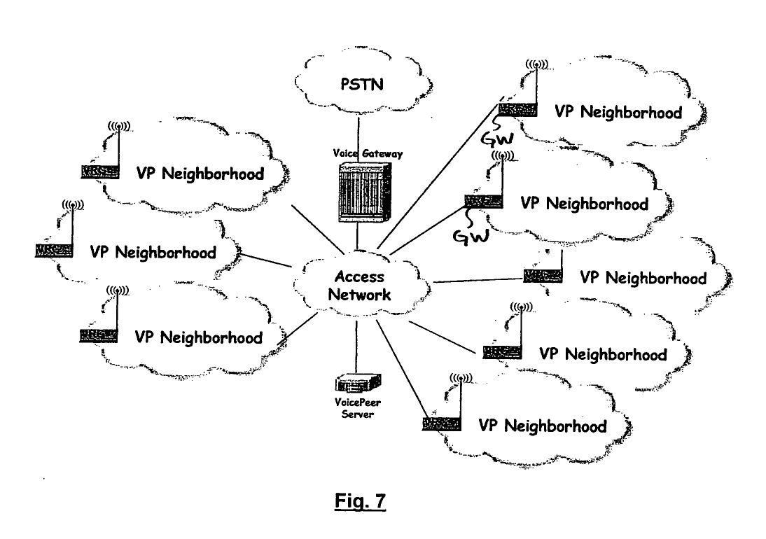

FIG. 7 is an architectural diagram of yet another embodiment of the present invention. The areas labeled “VP neighborhood” contain peer-to-peer networks according to the present invention.

In use, the system may be configured to use many channels of multiple access type, and thereby avoid co-channel interference problems. Such configuration may be done in many ways. If a GPS or other location type determination is made within the unit, channel and topology arrangements may be made by a central network configuration system or routine. In such an exemplar embodiment, the channel reuse pattern may be assigned by location and density. Such central configuration is not required, however. In one alternative embodiment, units 16 and 14 can be programmed to do “network discovery” by methods well known in the art. According to such an embodiment, a unit may be plugged in and turned on, and may then scan all channels to determine the presence and power level of infrastructure units 14 and P2P units 16 acting as Point Coordinators. It would then choose the highest power level signals to query for routing information and choose a location according to the best routed possible circuits. If the highest power level point coordinators (either infrastructure 14 or P2P 16 units) already have nearly full groups, the unit would then configure itself as a client for one of these groups, and as a Point Coordinator for a channel not already used in that area. Thus the next nearby units activated would then not be presented with Point Coordinators that had no more room in their groups.

Load balancing may be performed on the network in a number of ways. In one embodiment, if a particular area of the network is heavily loaded during peak traffic times, the infrastructure units 14 nearest the gateway GW, or the gateway GW itself can initiate a rediscovery algorithm that increases the density of infrastructure units 14 in that region. For instance, if the P2P units 16 were programmed to take the role of an infrastructure unit 14 on condition that they were more than 3 hops away from such a unit 14, the network rediscovery may change this number to 2 hops, and then initiate a rediscovery routine starting with the innermost (closest to the gateway) units in which the routing tables of each unit 14 and 16 are updated with the new topology of the network.

In another embodiment, the network can adjust load balancing by employing a method that does not involve frequent changes in topology (a process by which the network will slowly evolve to meet changing conditions and added units—updates to topology being performed at off-peak traffic hours) but rather involves switching of a virtual circuit while a call is in progress. If a call is initiated from a P2P or infrastructure unit and none of the virtual circuit paths in the routing table provide are able to provide a route that meets the latency requirements, there are a number of options available. First, the unit could request a new route be established through an area of the network reported to be not as congested. (The infrastructure units closest to the external gateway will contain the most relevant data points to make this consideration.) Or, alternatively, a call toward the outer side of the congested area could be re-routed to open up a slot in the congested area through which the new call could go, the new circuit route being chosen from the list of stored alternative routes the routing table of each unit.

While a preferred embodiment of the peer-to-peer wireless local loop phone system has been described in detail, it should be apparent that modifications and variations thereto are possible, all of which fall within the true spirit and scope of the invention. With respect to the above description then, it is to be realized that the optimum dimensional relationships for the parts of the invention, to include variations in size, form, function and manner of operation and use, are deemed readily apparent and obvious to one skilled in the art, and all equivalent relationships to those illustrated in the drawings and described in the specification are intended to be encompassed by the present invention. For example, any suitable air interface such as such as CDMA, TDMA, TDD, or combined multiple access schemes can be used. Also, the external network gateway described can be comprised of P2P units wired to a PBX, IP/PBX, class 4 or class 5 switch, one or more two wire loop lines wired into a custom gateway, or it can even be a cellular BTS, with the nearest ring of infrastructure units having dual functionality as traditional wireless local loop clients (using GSM, CDMA, DECT, or other wireless local loop standards) and peer-to-peer units. Further, it is apparent that this system can be used without an external gateway, to provide purely local communications in the manner of the earliest wired phone systems, or it can be configured with multiple external gateways.

Although providing local phone service without the use phone lines or central base stations with a peer-to-peer multi-hop wireless phone terminal have been described, it should be appreciated that the peer-to-peer wireless local loop phone system herein described is also suitable for providing data services as well, with those services taking lower priority than voice services by means such as are well known in the art for prioritizing quality of service on networks (the data service would be packet-switched while the voice service is routed with virtual circuits). Furthermore, a voice codec scheme can be used to lower the voice data rate during peak call times and thereby increase network capacity. Finally, prior art VoIP packet system can be used, or the transmission/routing scheme can be optimized to get rid of packet overhead and use a custom data transmission protocol, with conversion to whatever gateway interface standard (SS7, VoIP H323 or SIP, or combinations of these, for example) is needed being done at the gateway.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method of operating a plurality of peer-to-peer units to establish a virtual circuit traffic connection, the method comprising the following steps:
(a) choosing a predetermined route from a predetermined set of available routes to reach a selected destination,
(b) sending, from an originating unit, a request to establish a virtual circuit along said route to a terminating unit of said route within plurality of peer-to-peer units;
(c) determining whether said terminating unit is acting as a final-hop point coordinator,
(d) in response to a determining that said terminating unit is acting as a final-hop point coordinator, assigning a time slot for a final hop in the route;
(e) in response to determining that said terminating unit is not acting as a final-hop point coordinator, requesting a time slot for the final hop in the route from an alternative unit acting as a final hop point coordinator;
(f) transmitting information on said time slot to a previous unit in said route;
(g) determining whether said previous unit is acting as a present-hop point coordinator,
(h) in response to a determining that said terminating unit is acting as a present-hop point coordinator, assigning a time slot for a present hop in the route;
(i) in response to determining that said terminating unit is not acting as a present-hop point coordinator, requesting a time slot for the present hop in the route from an alternative unit acting as a present hop point coordinator;
(j) repeating steps (f), (g), (h) and (i) until said route is terminated at the originating unit requesting said route.

2. The method of claim 1 in which selected pairs of adjacent hops in said route are not transmitted on the same frequency.

3. The method of claim 1 in which transmit frequencies for each hop in said route are allocated according to a geographic distribution channel reuse scheme.

4. The method of claim 1 in which a selected one or more hops are at a higher transmit power than a selected one or more other hops.

5. A communications system comprising:
a plurality of wireless terminal units,
each of said wireless terminal units having a transmitter and a receiver,
each of said wireless terminal units being programmed to operate as an end terminal for a phone system and also to act as a relay node for select others of said wireless terminal units.

6. The communications system of claim 5, wherein each of said wireless terminal units may function both as a Point Coordinator for a first selected group of other wireless terminal units, and as a client in a second selected group of wireless terminal units with a second Point Coordinator.

7. The communications system of claim 5, wherein each of said wireless terminal units operating as a Point Coordinator is configured to perform Medium Access Control only as a Point Coordinator for substantially all of the time allotted to that unit as a Point Coordinator.

8. The communications system of claim 5, wherein each of said wireless terminal units operating as a Point Coordinator is configured to relay any virtual circuit connections not initiated or terminated at said wireless terminal unit from the group of wireless terminal units to the Point Coordinator of the group in which it participates as a client; and wherein said each of said wireless terminal units operating as a Point Coordinator is configured to relay a any virtual circuit connections not initiated or terminated at said wireless terminal unit from the Point Coordinator of the group in which it participates as a client to the group of wireless terminal units for which it servers as a point coordinator.

9. The communications system of claim 5 further comprising:
at least one external network gateway, said gateway having a connection to a communications network external to said communications system.

10. The communications system of claim 9 wherein said communications network is the PSTN.

11. The communications system of claim 9 wherein said communications network is the Internet.

12. The communications system of claim 5, wherein said wireless terminal units can function as a “infrastructure” unit if a number of hops to said external network gateway or to another infrastructure unit is greater than a predetermined number.

13. The communications system of claim 5 further comprising:
a phone handset attached to said wireless terminal unit.

14. The communications system of claim 5, wherein each of said wireless terminal units communicates on at least two sets of multiple access channels.

15. The communications system of claim 14, wherein said multiple access channels are selected from the group comprising Code Division Multiple Access, Frequency Division Multiple Access, Space Division Multiple Access, and Time Division Multiple Access.

16. A method of operating a plurality of peer-to-peer units to establish a virtual circuit traffic connection, the method comprising the following steps:
(a) choosing a predetermined route from a predetermined set of available routes to reach a selected destination,
(b) sending, from an originating unit, a request to establish a virtual circuit along said route to a terminating unit of said route within plurality of peer-to-peer units;
(c) determining a most-loaded unit from among the peer-to-peer units in the chosen route;
(d) determining whether said most-loaded unit is acting as a point coordinator,
(e) choosing an outgoing open time slot and an incoming open time slot at the most-loaded unit having a minimal latency among available outgoing and incoming time slots at the most-loaded unit;
(f) activating the outgoing and incoming time slots for use in establishing the virtual circuit connection;
(g) establishing, constrained by the timeslots chosen at the most-loaded unit, the virtual circuit connection in both directions along the chosen route by requesting next-available time slots at each hop in both directions.

17. The method of claim 1 in which selected pairs of adjacent hops in said route are not transmitted on the same frequency.

18. The method of claim 1 in which transmit frequencies for each hop in said route are allocated according to a geographic distribution channel reuse scheme.

19. The method of claim 1 in which a selected one or more hops are at a higher transmit power than a selected one or more other hops.

20. The method of claim 16, wherein said most-loaded unit is determined by each unit sending loading information along the requested path along with the initial request to establish a route.
